(19) United States
(12) Patent Application Publication
(10) Pub. No.: US 2015/0039237 A1
(43) Pub. Date: Feb. 5, 2015

(54) INDEXING GENE EXPRESSION DATA TO COMPARE GENE SIGNATURES

(71) Applicant: King Saud University, Riyadh (SA)

(72) Inventors: Haseeb Ahmad Khan, Riyadh (SA); Ibrahim Abdulwahid Arif, Riyadh (SA)

(73) Assignee: King Saud University, Riyadh (SA)

(21) Appl. No.: 14/202,487

(22) Filed: Mar. 10, 2014

Related U.S. Application Data
(63) Continuation of application No. PCT/US11/51147, filed on Sep. 12, 2011.

(51) Int. Cl. G06F 19/20

(52) U.S. Cl. CPC G06F 19/20
USPC 702/19

(57) ABSTRACT

Indexing gene expression data for comparing gene signatures includes assigning one of a plurality of fold change-based grading scores to each of a number of genes in a probe gene signature. The fold change-based grading scores reflect relative expression of one of the number of genes in the probe gene signature. Each of the number of genes in the probe gene signature assigned a particular grading score is weighted by the particular grading score. A ratio of each weighted number of genes in the probe gene signature assigned a particular grading score to a total number of genes in the probe gene signature is determined. Then, ratios of each weighted number of genes in the probe gene signature assigned each particular grading score to the total number of genes in the probe gene signature are summed to generate an index of gene expression.

### BACKGROUND

The pattern of expressed genes in DNA microarray data demonstrates a typical profile, such as in relation to a cancer type or disease severity. These unique sets of genes defining specific pathology are regarded as molecular “signatures” or “fingerprints” and have a potential to be as indispensable tools for diagnosis, prognosis and treatment of various types of cancers and diseases. Gene expression profiling may aid physicians to better understand cellular morphology, resistance to chemotherapy, and the clinical outcome of disease. This type of individualized treatment may significantly increase survival due to the optimization of treatment procedure in accordance with the clinical pathogenesis.

As far as the reliability and robustness of microarray techniques are concerned, microarray gene expressions have been found to be highly reproducible within and across high volume labs. Emergence of new gene signatures from wet lab microarray experiments have resulted in an exponential surge in microarray data. Although gene clustering is an important tool for the identification of like-groups in a microarray experiment, this methodology is not valid for two-group comparisons. Several statistical methods such as analysis of variance, Mann Whitney's U test, Pearson's correlation test, t-test, and Wilcoxon signed-rank test have been used for comparison of microarray data. However, these conventional statistical methods often result in spurious outputs when comparing microarray gene expression data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The described systems and methods relate to indexing gene expression data for comparing gene signatures. Such systems and methods may assign one of a plurality of fold change-based grading scores to each of a number of genes in a probe gene signature. The fold change-based grading scores reflect relative expression of one of the number of genes in the probe gene signature. Each of the number of genes in the probe gene signature assigned a particular grading score is weighted by the assigned grading score. A ratio is determined of each weighted number of genes in the probe gene signature assigned a particular grading score to a total number of genes in the probe gene signature. Then, the ratios of each weighted number of genes in the probe gene signature assigned each particular grading score to the total number of genes in the probe gene signature are summed to arrive at an index of gene expression.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates an example environment capable of implementing the systems and methods described herein, according to one embodiment.

FIG. 2 shows an exemplary procedure for indexing gene expression data for comparison of gene signatures, according to one embodiment.

FIG. 3 is a block diagram illustrating an exemplary computing device on which procedures for indexing gene expression data for comparison of gene signatures may be implemented, according to one embodiment.

### DETAILED DESCRIPTION

### Overview

The systems and methods described herein relate to indexing of gene expression data and its application for comparing gene signatures. The present systems and methods provide robust indexing for comparison of microarray expression data to provide clinical application of gene signatures. The index of gene expression provided by the present systems and methods may be referred to as the Haseeb Index of Gene Expression (HIGE) score, but may generally be referred to herein as an Index of Gene Expression (IGE) score.

Despite the influx of new gene signatures from wet lab microarray experiments, limited attempts have been made to establish a unified strategy for useful application of this exponentially surging microarray data. The present systems and methods employ an algorithm for robust indexing of gene expression data to compare gene signatures. The fold-change strategy used in the present systems and methods for indexing gene expression scores is robust, accurate and reproducible. Although fold-change has been used in microarray experiments, it has not been applied for collective interpretation of gene signatures. Conventionally, in a microarray experiment, the ratio of the color intensity of each spot location with a specific probe describes a relative expression of the corresponding gene under two different conditions. A gene is considered to be differentially expressed if the ratio of the expression levels between two groups exceeds predefined threshold values. The conventionally accepted expression ratios for up-regulated and down-regulated genes have been suggested to be greater than 1.5 and less than 0.5, respectively. The present systems and methods employ similar cut-off margins, but provide a more refined protocol using additional sub-grading of expression ratios.

Particular examples discussed herein are described with respect to cancer or other disease-related genes. However, the present invention can be utilized for indexing gene expression data for comparison of gene signatures for any type of genes. Also, particular examples discussed herein are described with respect to an algorithm employed in a general purpose processor-based computing device. However, the present invention can utilize any number of types of computing devices, by way of example a further enhanced DNA microarray, an Application Specific Integrated Circuit (ASIC), and/or the like.

### Exemplary Indexing Gene Expression Data for Comparison of Gene Signatures

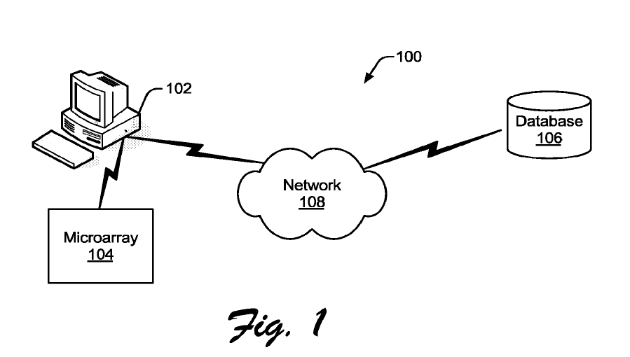

FIG. 1 illustrates an example environment 100 capable of implementing the systems and methods described herein. Environment 100 includes computing system 102 interfaced with microarray 104. Computing system 102 represents any type of computing device, such as a server, workstation, laptop computer, tablet computer, handheld computing device, smart phone, personal digital assistant, and the like. As discussed herein, computing system 102 receives gene expression data from microarray 104. Computing system 102 may also perform additional functions, such as executing application programs with respect to the microarray gene expression data, and the like. Computing system 102 may be coupled to a database 106 for storing information, such as standardized or known gene expression data, and/or the like. In alternate embodiments, database 106 is coupled directly to computing system 102, but as illustrated in FIG. 1 database 106 (and/or microarray 104) may be coupled to computing device 102 via data communication network 108.

Data communication network 108 represents any type of network, such as a local area network (LAN), wide area network (WAN), or the Internet. In particular embodiments, data communication network 108 is a combination of multiple networks communicating data using various protocols across any communication medium.

Although one computing system (102) is shown in FIG. 1, alternate embodiments may include any number of computing systems coupled together via any number of data communication networks 108 and/or communication links. In other embodiments, computing system may be replaced with any other type of computing device or replaced with a group of computing devices, such as servers or application specific appliances.

### An Exemplary Procedure

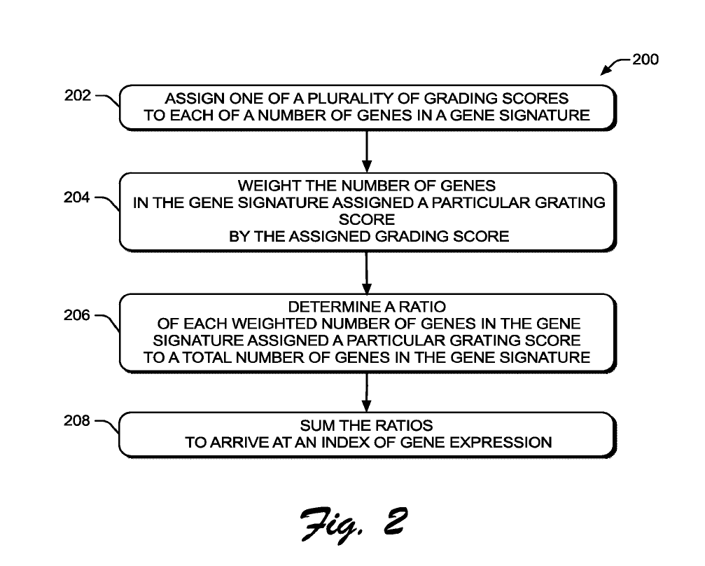

FIG. 2 shows exemplary procedure 200 for indexing gene expression data for comparison of gene signatures, according to one embodiment. Therein, procedure 200 comprises assigning one of a plurality of fold change-based grading scores to each of a number of genes in a probe gene signature at 202. In certain implementations, the fold change-based grading scores reflects relative expression of one of the number of genes in the probe signature. As noted above, the present systems and methods employ a refined protocol using a plurality of sub-grading of expression ratios, such as shown in Table 1, below. For example, in step 202, Nₓ may be set as the number of genes in the probe gene expression with grading score G_{y}, relative to the gene expression the probe is being compared. The subscript ‘x’ can vary between zero and total number of genes in a signature (Nₜ) and ‘y’ can vary between zero and one, such as in accordance with Table 1, below.

TABLE 1
Grading system for categorizing differential
expression of gene signatures

| | | Grading | |
|---|---|---|---|
| No. | Fold change | Score | Comments |
| 1 | <0.03125 | 1.0 | Down-regulation |
| 2 | ≧0.03125 and <0.0625 | 0.8 | Down-regulation |
| 3 | ≧0.0625 and <0.125 | 0.6 | Down-regulation |
| 4 | ≧0.125 and <0.25 | 0.4 | Down-regulation |
| 5 | ≧0.25 and <0.50 | 0.2 | Down-regulation |
| 6 | ≧0.50 and ≦1.5 | 0.0 | Norm-regulation |
| 7 | >1.5 and ≦3.0 | 0.2 | Up-regulation |
| 8 | >3.0 and ≦6.0 | 0.4 | Up-regulation |
| 9 | >6.0 and ≦12.0 | 0.6 | Up-regulation |
| 10 | >12.0 and ≦24.0 | 0.8 | Up-regulation |
| 11 | >24.0 | 1.0 | Up-regulation |

At 204, each of the number of genes in the probe gene signature assigned a particular grading score are weighted by the assigned particular grading score. Such weighting might entail, by way of example, finding the product of a number of genes in the gene signature Nₓ with each of a plurality of grading scores and the respective grading score G_{y}.

A ratio of each weighted number of genes in the probe gene signature assigned a particular grading score to a total number of genes in the gene signature is determined at 206. For example, the quotient of the product of the number of genes in the gene signature with each of the plurality of grading scores and the respective grading score (NₓG_{y}) with respect to the total number of genes in the gene signature (Nₜ) may be found at 206.

The ratios of each weighted number of genes in the probe gene signature assigned each particular grading score to a total number of genes in the gene signature are summed at 208 to arrive at an index of gene expression. This index of gene expression may be expressed as a percent, such as may be achieved by multiplying the sum of ratios of each weighted number of genes in the gene signature assigned a particular grading score to a total number of genes in the gene signature by one-hundred.

Thus, in accordance with various implementations of the present systems and methods, a formula for arriving at the IGE score may be expressed as:

IGE=[ΣNₓG_{y}/Nₜ]100

where Nₓ is the number of genes with grading score G_{y}. As noted above, the subscript ‘x’ can vary between 0 and total number of genes in a signature (Nₜ) and ‘y’ can vary between 0 and 1. (See Table 1, above.)

Thus, applying this formula to process 200, the gene expression ratios of DNA microarray data may be categorized according to a logically defined scale, such as shown in Table 1 above, to arrive at the respective Nₓ and G_{y} values at 202. The percent contributions of each set of genes, that is the genes with the same expression score, are computed at 204 and 206 and their summation, found at 208, is regarded as the IGE score.

### An Exemplary Computing System

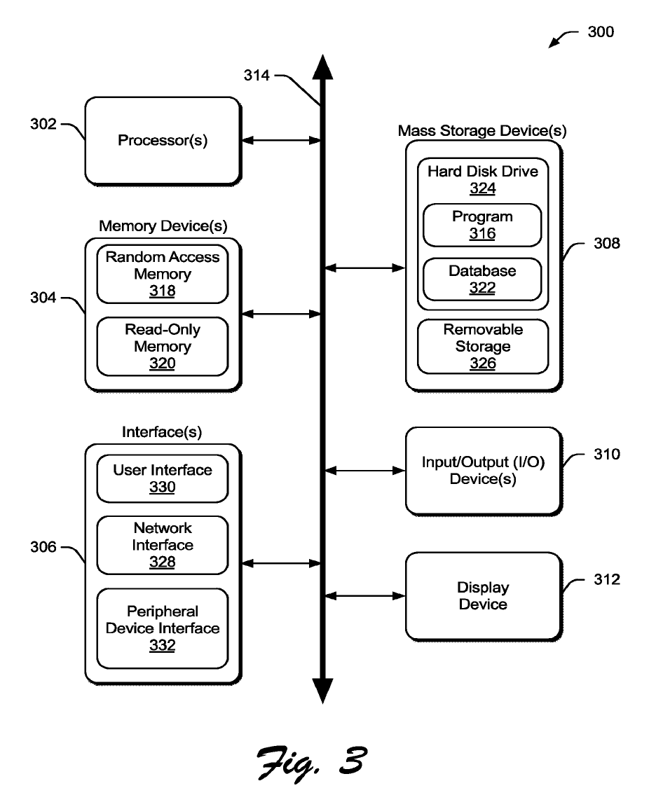

FIG. 3 illustrates an example-computing environment capable of implementing the systems and methods described herein, according to one embodiment. Example computing device 300 may be used to perform various procedures, such as those discussed herein, particularly with respect to procedure 200 of FIG. 2. Computing device 300 can function as, by way of example, computing system 102 of FIG. 1, or alternatively as a server, a client, a work node, or any other computing entity. Computing device 300 can be any of a wide variety of computing devices, such as a desktop computer, a notebook computer, a server computer, a handheld computer, a work station, and/or the like.

Computing device 300 includes one or more processor(s) 302, one or more memory device(s) 304, one or more interface(s) 306, one or more mass storage device(s) 308, one or more Input/Output (I/O) device(s) 310, and a display device 312 all of which are coupled to a bus 314. Processor(s) 302 include one or more processors or controllers that execute instructions stored in memory device(s) 304 and/or mass storage device(s) 308, such as one or more programs (316) implementing process 200 of FIG. 2. Processor(s) 302 may also utilize various types of computer-readable media such as cache memory (e.g., incorporated by memory device(s) 304).

Memory device(s) 304 include various computer-readable media, such as volatile memory (e.g., random access memory (RAM)) 318 and/or nonvolatile memory (e.g., read-only memory (ROM) 320). Memory device(s) 304 may also include rewritable ROM, such as Flash memory.

Mass storage device(s) 308 include various computer readable media, such as magnetic tapes, magnetic disks, optical disks, solid-state memory (e.g., Flash memory), and so forth. Program 316 implementing process 200 may be stored in such mass storage. Data, such as one or more databases 322 containing, by way of example, standardized or known gene expression data, and/or the like, may also be stored on mass storage device(s) 308. As shown in FIG. 3, a particular mass storage device may be a local hard disk drive 324, which may store program 316 and/or database 322. Various drives may also be included in mass storage device(s) 308 to enable reading from and/or writing to the various computer readable media. Mass storage device(s) 308 include removable media 326 and/or non-removable media and/or remote drives or databases accessible by system 300.

I/O device(s) 310 include various devices that allow data and/or other information to be input to or retrieved from computing device 300. Example I/O device(s) 310 might include the afore mentioned microarray 104, cursor control devices, keyboards, keypads, microphones, monitors or other display devices, speakers, printers, network interface cards, modems, lenses, CCDs or other image capture devices, and the like.

Display device 312 is optionally directly coupled to the computing device 300. If display device 312 is not coupled to device 300, such a device is operatively coupled to another device that is operatively coupled to device 300 and accessible by a user of the results of method 200. Display device 312 includes any type of device capable of displaying information to one or more users of computing device 300, such as the IGE results of process 200. Examples of display device 312 include a monitor, display terminal, video projection device, and the like.

Interface(s) 306 include various interfaces that allow computing device 300 to interact with other systems, devices, or computing environments. Example interface(s) 306 include any number of different network interfaces 328, such as interfaces to local area networks (LANs), wide area networks (WANs), wireless networks, and the Internet. As alluded to above, a microarray, such as microarray 104 of FIG. 1, may be directly interfaced with computing device 300 or coupled to device 300 via a network, the Internet, or the like. Other interfaces include user interface 330 and peripheral device interface 332.

Bus 314 allows processor(s) 302, memory device(s) 304, interface(s) 306, mass storage device(s) 308, and I/O device(s) 310 to communicate with one another, as well as other devices or components coupled to bus 314. Bus 314 represents one or more of several types of bus structures, such as a system bus, PCI bus, IEEE 1394 bus, USB bus, and so forth.

For purposes of illustration, programs and other executable program components, such as program 316, are shown herein as discrete blocks, although it is understood that such programs and components may reside at various times in different storage components of computing device 300, and are executed by processor(s) 302.

Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

### Exemplary Implementation and Case Study Results

The present systems and methods have been validated using simulated gene signatures with known differences. The resultant IGE scores have been compared with the outputs of seven nonparametric tests. This case study cross-checks the validity of various statistical methods for two group comparison of gene signatures using carefully designed sets of simulated data. Due to the format of expression data, the conventional statistical methods largely failed to perform accurately and consistently for comparison of gene signatures. However, the present IGE offered a robust and authenticated indexing system for comparing microarray gene signatures.

To evaluate the validity of conventional nonparametric statistical tests for comparison of gene signatures, six pairs of expression data (e.g., Pair-1 through Pair-6) were designed to represent various degrees of similarities or differences. The two groups in Pair-4 and Pair-6 represented the minimum and maximum differences, respectively. All six pairs were subjected to statistical comparisons using the conventional Friedman test, the conventional Kendall W test, the conventional Kolmogorov-Smirnov test, the conventional Kruskal-Wallis test, the conventional Mann-Whitney U test, the conventional Wilcoxon signed rank test, and the conventional Sign test, using SPSS statistical analysis software package. The IGE scores obtained in accordance with the present systems and methods were compared in parallel to the outputs of these tests, as detailed in Table 2, below.

TABLE 2
Validation for comparisons of simulated gene expression data
using different statistical methods and IGE

| | IGE score or two-tailed P value | | | | | |
|---|---|---|---|---|---|---|
| Test | Pair-1 | Pair-2 | Pair-3 | Pair-4 | Pair-5 | Pair-6 |
| IGE Score | 60 | 45 | 50 | 0 | 4 | 100 |
| Friedman test | 1 | 1 | 1 | 1 | 0.001 | 1 |
| Kendall W test | 1 | 1 | 1 | 1 | 0.001 | 1 |
| Kolmogorov- | 0.001 | 0.001 | 1 | 0.001 | 0.001 | 0.001 |
| Smirnov test | | | | | | |
| Kruskal | 1 | 1 | 1 | 1 | 0.001 | 1 |
| Wallis test | | | | | | |
| Mann Whitney | 1 | 1 | 1 | 1 | 0.001 | 1 |
| U test | | | | | | |
| Sign test | 1 | 1 | 1 | 1 | 0.001 | 1 |
| Wilcoxon | 0.007 | 0.007 | 1 | 1 | 0.001 | 0.006 |
| signed | | | | | | |
| rank test | | | | | | |

The results of this validation using simulated signatures clearly show paradoxical outcomes while comparing six gene signatures using the seven conventional nonparametric tests. This indicates the incompatibility of conventional statistics for comparing gene expression data. (See Table 2, above.) Five of the tests, including the Friedman test, the Kendall W test, the Kruskal-Wallis test, the Mann-Whitney U test and the Sign test provided the same results, but logically unrealistic P values for all six of the signature pairs. These tests show a P value of one for a gene signature with maximum difference (Pair 6) and P=0.001 for a signature with a slight difference (Pair 5); the corresponding IGE scores obtained in accordance with the present systems and methods for these signatures were 100 and 4, respectively (See Table 2, above). The remaining two conventional tests, the Kolmogorov-Smirnov test and the Wilcoxon signed-rank test, also failed to efficiently handle these statistical comparisons. On the other hand, the IGE scores obtained in accordance with the present systems and methods effectively quantitated the differences or similarities between the groups of each pair.

The results of this validation clearly demonstrate the failure of conventional statistical methods to handle the microarray expression data, particularly for two-group comparison of gene signatures. The present IGE systems and methods provide a more accurate and unified system that enables routine and uniform clinical application of gene signature. The present systems and methods are a convenient and robust means for comparison of gene signatures. IGE scores obtained in accordance with the present systems and methods are intuitive to interpret and comparison of the collective expression of molecular signatures straightforward.

The applicability of IGE scores has also been validated using actual signatures data of two different cancer types including ulcerative colitis (“Signature 1” from Dooly et al., Inflamm. Bowel. Dis., 2004, 10, 1-14) and ovarian cancer (“Signature 2” from Wang et al., Gene, 1999, 229, 101-108). The characteristics of these signatures are summarized in Table 3 and the results obtained using various statistical methods are shown in Table 4, below.

TABLE 3
Characteristics of Gene Signatures 1 and 2

| | Number | Number | | |
|---|---|---|---|---|
| | of over- | of under- | Total | |
| | expressed | expressed | number | |
| Signature | genes | genes | of genes | Reference |
| 1. Ulcerative colitis | 11 | 12 | 23 | Dooly et al, 2004 |
| 2. Ovarian cancer | 15 | 15 | 30 | Wang et al, 1999 |

TABLE 4
Validation of IGE scores using the Gene Signatures 1 and 2.

| | IGE score or two-tailed P value | |
|---|---|---|
| | Gene Signature 1 | Gene Signature 2 |
| Statistical test | Ulcerative colitis | Ovarian cancer |
| IGE Score | 36.500 | 42.000 |
| Friedman test | 0.835 | 1.000 |
| Kendall W test | 0.835 | 1.000 |
| Kolmogorov-Smirnov test | 0.010 | 0.001 |
| Kruskal Wallis test | 0.399 | 1.000 |
| Mann Whitney U test | 0.399 | 1.000 |
| Sign test | 1.000 | 1.000 |
| Wilcoxon signed rank test | 0.067 | 0.021 |

The results of this validation also clearly demonstrate the failure of conventional statistical methods to consistently handle the microarray expression data, as there was a huge disparity in the P values obtained from different statistical tests. However, the IGE scores provide robust and straightforward comparisons that are comparable to the known expression data for these signatures.

### Alternate Embodiments

Although the systems and methodologies for indexing gene expression data for comparison of gene signatures have been described in language specific to structural features and/or methodological operations or actions, it is understood that the implementations defined in the appended claims are not necessarily limited to the specific features or actions described. For example, although the described systems and methods may refer to the use of microarray data, gene expression data from any source may be used in accordance with embodiments of the present systems and methods. Accordingly, the specific features and operations of the described systems and methods of indexing gene expression data for comparison of gene signatures are disclosed as exemplary forms of implementing the claimed subject matter.

1. A computer implemented method for indexing gene expression data for comparison of gene signatures comprising:
assigning one of a plurality of fold change-based grading scores to each of a number of genes in a probe gene signature, the fold change-based grading scores reflecting relative expression of one of the number of genes in the probe gene signature;
weighting each of the number of genes in the probe gene signature assigned a particular grading score by the particular grading score;
determining a ratio of each weighted number of genes in the probe gene signature assigned a particular grading score to a total number of genes in the probe gene signature; and
summing the ratios of each weighted number of genes in the probe gene signature assigned each particular grading score to the total number of genes in the probe gene signature to arrive at an index of gene expression.

2. The computer implemented method of claim 1, wherein the probe gene signature is provided by a microarray.

3. The computer implemented method of claim 1, wherein arriving at the index of gene expression further comprises expressing the index of gene expression as a percent.

4. The computer implemented method of claim 1, wherein arriving at the index of gene expression further comprises multiplying the sum of ratios of each weighted number of genes in the probe gene signature assigned a particular grading score to the total number of genes in the probe gene signature by one-hundred.

5. The computer implemented method of claim 1, wherein weighting the number of genes in the probe gene signature assigned a particular grading score by the assigned grading score comprises finding the product of the number of genes in the probe gene signature assigned a particular grading score and the assigned grading score.

6. The computer implemented method of claim 1, wherein determining a ratio of each weighted number of genes in the probe gene signature assigned a particular grading score to a total number of genes in the probe gene signature comprises finding the quotient of a product of the number of genes in the probe gene signature with each of the plurality of grading scores and the respective grading score to the total number of genes in the probe gene signature.

7. The computer implemented method of claim 1, wherein the grading score for a fold change greater than or equal to 0.50 and less than or equal to 1.5 is zero.

8. The computer implemented method of claim 1, wherein the grading score for a fold change less than 0.03125 or greater than 24.0 is 1.0.

9. The computer implemented method of claim 1, wherein the grading score for a fold change greater than or equal to 0.25 and less than 0.50 or greater than 1.5 and less than or equal to 3.0 is 0.2.

10. The computer implemented method of claim 1, wherein the grading score for a fold change greater than or equal to 0.125 and less than 0.25 or greater than 3.0 and less than or equal to 6.0 is 0.4.

11. The computer implemented method of claim 1 wherein the grading score for a fold change greater than or equal to 0.0625 and less than 0.125 or greater than 6.0 and less than or equal to 12.0 is 0.6.

12. The computer implemented method of claim 1 wherein the grading score for a fold change greater than or equal to 0.03125 and less than 0.0625 or greater than 12.0 and less than or equal to 24.0 is 0.8.

13. A tangible computer program medium comprising computer program instructions executable by a processor, the computer program instructions, when implemented by the processor for performing operations comprising:
assigning one of a plurality of fold change-based grading scores to each of a number of genes in a probe gene signature, the fold change-based grading scores reflecting relative expression of one of the number of genes in the probe gene signature;
weighting each of the number of genes in the probe gene signature assigned a particular grading score by the particular grading score;
determining a ratio of each weighted number of genes in the probe gene signature assigned a particular grading score to a total number of genes in the probe gene signature; and
summing the ratios of each weighted number of genes in the probe gene signature assigned each particular grading score to the total number of genes in the probe gene signature to arrive at an index of gene expression.

14. The tangible computer program medium as recited in claim 13, wherein arriving at the index of gene expression further comprises expressing the index of gene expression as a percent.

15. The tangible computer program medium as recited in claim 13, wherein:
the grading score for a fold change greater than or equal to 0.50 and less than or equal to 1.5 is zero;
the grading score for a fold change less than 0.03125 or greater than 24.0 is one; and
the grading score for a fold change less than 0.50 and greater than or equal to 0.03125, or greater than 1.5 and less than or equal to 24.0, is greater than zero and less than one.

16. The tangible computer program medium as recited in claim 15, wherein:
the grading score for a fold change greater than or equal to 0.25 and less than 0.50 or greater than 1.5 and less than or equal to 3.0 is 0.2;
the grading score for a fold change greater than or equal to 0.125 and less than 0.25 or greater than 3.0 and less than or equal to 6.0 is 0.4;
the grading score for a fold change greater than or equal to 0.0625 and less than 0.125 or greater than 6.0 and less than or equal to 12.0 is 0.6; and
the grading score for a fold change greater than or equal to 0.03125 and less than 0.0625 or greater than 12.0 and less than or equal to 24.0 is 0.8.

17. One or more computing devices comprising one or more respective processors operatively coupled to respective memory, each memory comprising computer program instructions executable by a processor to implement a method for indexing gene expression data to compare gene signatures comprising:
assigning one of a plurality of fold change-based grading scores to each of a number of genes in a probe gene signature, the fold change-based grading scores reflecting relative expression of one of the number of genes in the probe gene signature;
weighting each of the number of genes in the probe gene signature assigned a particular grading score by the particular grading score;
determining a ratio of each weighted number of genes in the probe gene signature assigned a particular grading score to a total number of genes in the probe gene signature; and
summing the ratios of each weighted number of genes in the probe gene signature assigned each particular grading score to the total number of genes in the probe gene signature to arrive at an index of gene expression.

18. One or more computing devices as recited in claim 17, wherein the probe gene signature is provided by a microarray in communication with the one or more computing devices.

19. One or more computing devices as recited in claim 17, wherein:
the grading score for a fold change greater than or equal to 0.50 and less than or equal to 1.5 is zero;
the grading score for a fold change less than 0.03125 or greater than 24.0 is one; and
the grading score for a fold change less than 0.50 and greater than or equal to 0.03125, or greater than 1.5 and less than or equal to 24.0, is greater than zero and less than one.

20. One or more computing devices as recited in claim 18, wherein:
the grading score for a fold change greater than or equal to 0.25 and less than 0.50 or greater than 1.5 and less than or equal to 3.0 is 0.2;
the grading score for a fold change greater than or equal to 0.125 and less than 0.25 or greater than 3.0 and less than or equal to 6.0 is 0.4;
the grading score for a fold change greater than or equal to 0.0625 and less than 0.125 or greater than 6.0 and less than or equal to 12.0 is 0.6; and
the grading score for a fold change greater than or equal to 0.03125 and less than 0.0625 or greater than 12.0 and less than or equal to 24.0 is 0.8.
